(19) United States
(12) Patent Application Publication
(10) Pub. No.: US 2026/0333269 A1
(43) Pub. Date: Oct. 22, 2026

(54) METHOD AND USER EQUIPMENT OF TIMING ADVANCE ACQUISITION

(71) Applicant: Industrial Technology Research Institute, Hsinchu (TW)

(72) Inventor: Nai-Lun Huang, Hsinchu County (TW)

(73) Assignee: Industrial Technology Research Institute, Hsinchu (TW)

(21) Appl. No.: 19/529,119

(22) Filed: Feb. 4, 2026

Related U.S. Application Data
(60) Provisional application No. 63/754,578, filed on Feb. 6, 2025.

(51) Int. Cl. H04W 56/00; H04W 36/00; H04W 74/00; H04W 74/0833; H04W 76/50

(52) U.S. Cl. CPC H04W 56/0045; H04W 36/0016; H04W 74/006; H04W 74/0833; H04W 76/50

(57) ABSTRACT

A method of timing advance (TA) acquisition and a user equipment are provided. The method includes: receiving a cell switch configuration comprising at least one candidate cell configuration; receiving a TA command associated with one of the at least one candidate cell configuration; storing a TA value in the TA command for the one of the at least one candidate cell configuration; and starting a TA timer associated with the one of the at least one candidate cell configuration.

### CROSS-REFERENCE TO RELATED APPLICATION

This application claims the priority benefit of U.S. provisional application serial no. 63/754,578, filed on Feb. 6, 2025. The entirety of the above-mentioned patent application is hereby incorporated by reference herein and made a part of this specification.

### BACKGROUND

### Technical Field

The disclosure is directed to a method and a user equipment (UE) of timing advance (TA) acquisition.

### Description of Related Art

L1/L2 triggered mobility (LTM) can be categorized into non-conditional LTM and conditional LTM (C-LTM). In non-conditional LTM, the network directly commands the UE to perform cell switch, while in C-LTM, the UE autonomously triggers cell switch based on pre-configured execution conditions.

### SUMMARY

The disclosure is directed to a method and a UE of TA acquisition. The disclosure may enable the UE to receive a TA command, store a TA value in the TA command and start an associated TA timer .

The present disclosure is directed to a method of timing advance (TA) acquisition, adapted to a user equipment, including: receiving a cell switch configuration including at least one candidate cell configuration; receiving a TA command associated with one of the at least one candidate cell configuration; storing a TA value in the TA command for the one of the at least one candidate cell configuration; and starting a TA timer associated with the one of the at least one candidate cell configuration.

In one embodiment of the present disclosure, the method further including: in response to the one of the at least one candidate cell configuration being released, stopping the TA timer associated with the one of the at least one candidate cell configuration, if exist and running; and releasing the stored TA value for the one of the at least one candidate cell.

In one embodiment of the present disclosure, the method further including: in response to the TA timer expiring, initiating a random access procedure; and considering a random access channel (RACH)-based cell switch to be ongoing.

In one embodiment of the present disclosure, the method further including: receiving a second TA command associated with the one of the at least one candidate cell configuration; storing a second TA value in the second TA command for the one of the at least one candidate cell configuration; and re-starting the TA timer associated with the one of the at least one candidate cell configuration.

In one embodiment of the present disclosure, the method further including: transmitting a random access preamble associated with the one of the at least one candidate cell configuration.

In one embodiment of the present disclosure, an index of the random access preamble is received by the user equipment via a step of receiving the TA command associated with the one of the at least one candidate cell configuration or the second TA command associated with the one of the at least one candidate cell configuration, wherein the step is performed prior to the random access preamble being transmitted.

In one embodiment of the present disclosure, the step of transmitting the random access preamble associated with the one of the at least one candidate cell configuration is initiated by a physical downlink control channel (PDCCH) order.

In one embodiment of the present disclosure, the random access preamble is used in an N-th subsequent physical random access channel (PRACH) occasion after receiving the index of the random access preamble, wherein N is a positive integer.

In one embodiment of the present disclosure, the random access preamble is used in a latest physical random access channel (PRACH) occasion before the TA timer expires.

In one embodiment of the present disclosure, the step of transmitting the random access preamble associated with the one of the at least one candidate cell configuration is performed a time offset before the TA timer expires.

In one embodiment of the present disclosure, the step of transmitting the random access preamble associated with the one of the at least one candidate cell configuration is performed after the TA timer expires.

In one embodiment of the present disclosure, the cell switch configuration further includes at least one execution condition, and the method further including: evaluating the at least one execution condition.

In one embodiment of the present disclosure, each one of the at least one execution condition is associated with each one of the at least one candidate cell configuration.

In one embodiment of the present disclosure, the each one of the at least one execution condition includes a primary execution condition, a secondary execution condition, and an emergency execution condition, wherein the primary execution condition is a first measurement-based condition, the secondary execution condition is associated with a validity of TA value, and the emergency execution condition is a second measurement-based condition.

In one embodiment of the present disclosure, the method further including: determining whether the primary execution condition in one of the at least one execution condition is met; in response to the primary execution condition in the one of the at least one execution condition being met, determining whether the secondary execution condition in the one of the at least one execution condition is met; in response to the secondary execution condition in the one of the at least one execution condition being met, performing the cell switch as a random access channel (RACH)-less cell switch; in response to the secondary execution condition in the one of the at least one execution condition not being met, determining whether the emergency condition in the one of the at least one execution condition is met; in response to the emergency condition in the one of the at least one execution condition being met, performing the cell switch as a RACH-based cell switch; and in response to the emergency condition in the one of the at least one execution condition not being met, transmitting a random access preamble associated with the one of the at least one candidate cell configuration.

The present disclosure is directed to a user equipment, including a transceiver and a processor. The processor is coupled to the transceiver, wherein the processor is configured to: receive a cell switch configuration via the transceiver, wherein the cell switch configuration includes at least one candidate cell configuration; receive a timing advance (TA) command associated with one of the at least one candidate cell configuration; store a TA value in the TA command for the one of the at least one candidate cell configuration; and start a TA timer associated with the one of the at least one candidate cell configuration.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a signaling diagram of execution of C-LTM according to one embodiment of the present disclosure.

FIG. 2 illustrates a signaling diagram of TA value update initiated by the UE according to one embodiment of the present disclosure.

FIG. 3 illustrates a signaling diagram of TA value update initiated by the UE according to one embodiment of the present disclosure.

FIG. 4 illustrates a signaling diagram of TA value update initiated by the UE according to one embodiment of the present disclosure.

FIG. 5 illustrates a signaling diagram of TA value update initiated by the UE according to one embodiment of the present disclosure.

FIG. 6 illustrates a schematic diagram of UE behaviour when C-LTM execution condition is met according to one embodiment of the present disclosure.

FIG. 7 illustrates a signaling diagram of TA value update initiated by the UE according to one embodiment of the present disclosure.

FIG. 8 illustrates a signaling diagram of TA value update initiated by the UE according to one embodiment of the present disclosure.

FIG. 9 illustrates a signaling diagram of TA value update initiated by the UE according to one embodiment of the present disclosure.

FIG. 10 illustrates a signaling diagram of TA value update initiated by the UE according to one embodiment of the present disclosure.

FIG. 11 illustrates a signaling diagram of TA value update initiated by the UE according to one embodiment of the present disclosure.

FIG. 12 illustrates a schematic diagram of UE behaviour when C-LTM execution condition is met according to one embodiment of the present disclosure.

FIG. 13 illustrates a signaling diagram of TA value update initiated by the network according to one embodiment of the present disclosure.

FIG. 14 illustrates a schematic diagram of UE behaviour when C-LTM execution condition is met according to one embodiment of the present disclosure.

FIG. 15 illustrates a signaling diagram of TA value update initiated by the network according to one embodiment of the present disclosure.

FIG. 16 illustrates a schematic diagram of UE behaviour when C-LTM execution condition is met according to one embodiment of the present disclosure.

FIG. 17 illustrates a signaling diagram of TA value update according to one embodiment of the present disclosure.

FIG. 18 illustrates a signaling diagram of TA value update according to one embodiment of the present disclosure.

FIG. 19 illustrates a flowchart of a method of timing advance (TA) update according to one embodiment of the present disclosure.

FIG. 20 illustrates a schematic diagram of UE according to one embodiment of the present disclosure.

### DESCRIPTION OF THE EMBODIMENTS

The network can configure measurement reports (e.g., L1 periodic, semi-persistent, aperiodic, or event triggered report) or L3 measurement reports for conditional LTM (e.g., to trigger physical downlink control channel (PDCCH) ordered early RACH). An early TA can be signaled to the UE from the source cell (e.g., not from the candidate cell directly to the UE). The network can inform the candidate cell’s TA information to the UE via a medium access control (MAC) control element (CE), wherein the candidate cell’s TA information can be a TA value when the UE switches to the candidate cell during the C-LTM. The candidate cell TA can be maintained by a timer (e.g., TA timer).

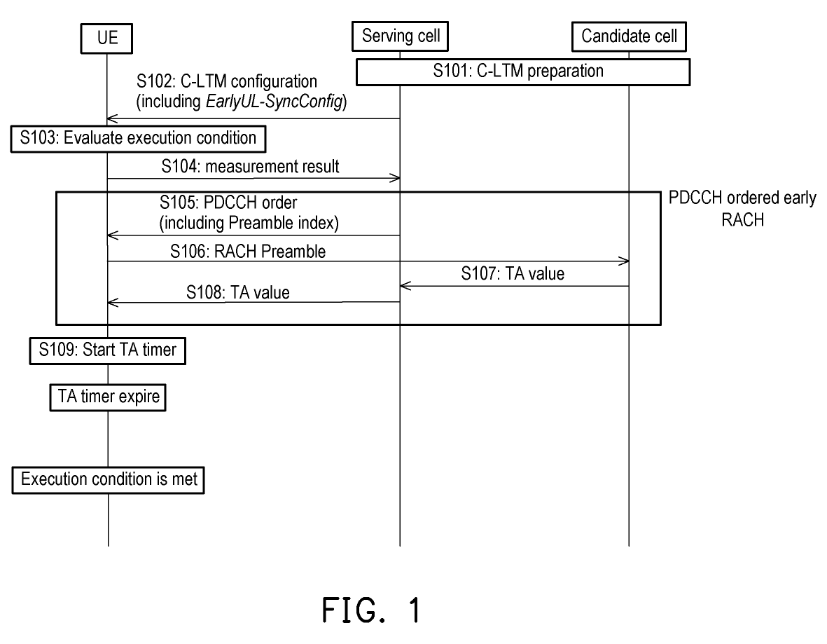

In some cases, the previously acquired TA value may be expired before the C-LTM cell switch is executed. FIG. 1 illustrates a signaling diagram of execution of C-LTM according to one embodiment of the present disclosure. In step S101, the serving cell and the candidate cell may perform C-LTM preparation. In step S102, the serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. EarlyUL-SynConfig may be configured with resources needed for the early uplink (UL) synchronization, wherein the resources may include a set of RACH (or physical RACH (PRACH)) preambles and the UL resources for the UE to transmit the RACH preamble. In step S103, the UE may evaluate the execution conditions in the cell switch configuration, wherein each one of the execution conditions may be associated with each one of the candidate cell configurations. In step S104, the UE may report the measurement result to the serving cell. The network (e.g., serving cell) may determine whether to trigger a PDCCH ordered early RACH according to the measurement result.

If the network determines to trigger the PDCCH ordered early RACH, in step S105, the serving cell may transmit a PDCCH order including a preamble index to the UE, so as to inform the UE which RACH preamble should be used. That is, the PDCCH order may initiate the transmitting of the RACH preamble. In step S106, the UE may transmit a RACH preamble corresponding to the preamble index to the candidate cell, wherein the RACH preamble may be associated with one of the candidate cell configurations. In step S107, in response to the RACH preamble, the candidate cell may transmit a TA value corresponding to the one of the candidate cell configurations to the serving cell. In step S108, the serving cell may forward the TA value to the UE, and the serving cell may configure a TA timer for the UE, wherein the TA timer can be used for determining the validity of the TA value. For example, the serving cell may transmit a TA command including the TA value to the UE. The UE may store the TA value in the storage medium of the UE. In step S109, the UE may start the TA timer associated with the one of the candidate cell configurations. If the one of the candidate cell configurations is released and if the TA timer associated with the one of the candidate cell configurations is existed and running, the UE may stop the TA timer and release the TA value for the one of the candidate cell configurations.

The execution condition for the conditional cell switch may not be met while the TA timer is running. If the execution condition is met after the TA timer expires, the TA value would be invalid and RACH-less cell switch execution would not be achievable.

In order to facilitate RACH-less cell switch execution, early TA update mechanisms can be introduced. The TA update can be initiated by the UE. The TA value can be updated if the previously acquired TA value expires before the C-LTM cell switch is executed.

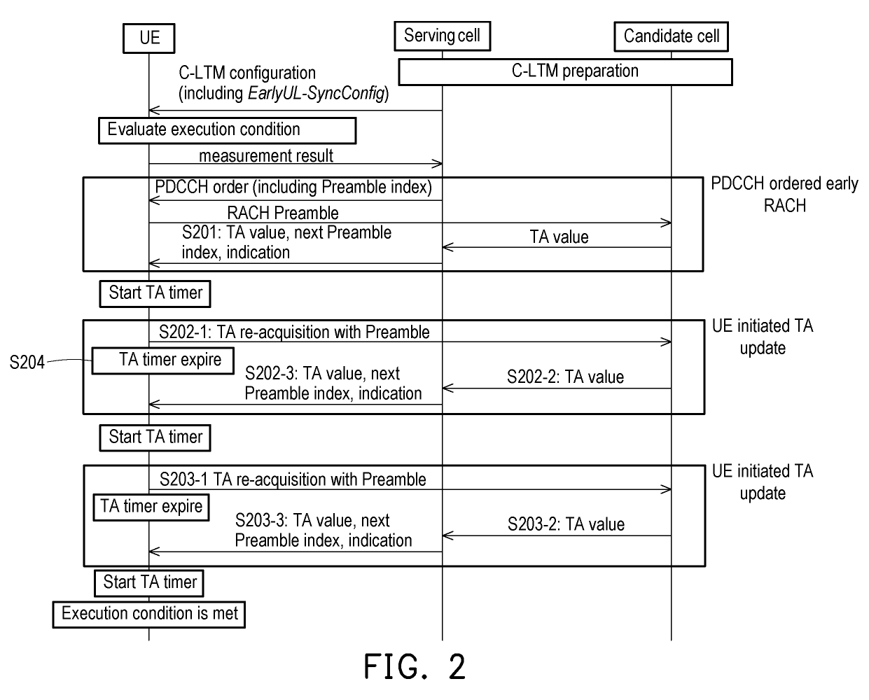

FIG. 2 illustrates a signaling diagram of TA value update initiated by the UE according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S201, the serving cell may transmit a TA value, and a next preamble index. In an example, the serving cell may further transmit an indication to the UE, wherein the indication may indicate that the RACH preamble corresponding to the next preamble index will be used on the N-th subsequent RACH (or PRACH) occasion after the TA value (or the next preamble index) is received by the UE, where N is a positive integer. The UE may store the TA value, the next preamble index, or the indication.

The RACH preamble can be used for TA acquisition or TA re-acquisition. For example, the UE may perform the TA acquisition/re-acquisition by transmitting the RACH preamble to the candidate cell.

After the UE starts the TA timer corresponding to the TA value, the UE may initiate TA update. Specifically, in step S202-1, the UE may transmit a TA re-acquisition message with the preamble (e.g., preamble corresponding to the preamble index provided via previous TA acquisition or TA re-acquisition, for example, preamble corresponding to the next preamble index provided in step S201) to the candidate cell. In step S202-2, in response to the RACH preamble, the candidate cell may transmit a TA value to the serving cell. In step S202-3, the serving cell may transmit a TA command to the UE, wherein the TA command may include a TA value and a next preamble index. In one example, the serving cell may further transmit an indication, wherein the indication may indicate that the RACH preamble corresponding to the next preamble index will be used in the N-th subsequent RACH (or PRACH) occasion after the TA value (or the next preamble index) is received by the UE, where N is a positive integer. The UE may store the TA value, the next preamble index, and the indication. The TA command can be received by the UE after the TA timer expires (e.g., previous acquired TA (e.g., TA value in step S201) becomes invalid). After the TA timer expires, the previous acquired TA value becomes invalid, and the RACH-less cell switch will be no longer achievable without TA update.

After the UE starts the TA timer corresponding to the TA value (e.g., TA value provided in step S202-3), the UE may initiate TA update. Specifically, in step S203-1, the UE may transmit a TA re-acquisition message with the preamble (e.g., preamble corresponding to the preamble index provided via previous TA acquisition or TA re-acquisition, for example, preamble corresponding to the next preamble index provided in step S202-3) to the candidate cell. In step S203-2, in response to the RACH preamble, the candidate cell may transmit a TA value to the serving cell. In step S203-3, the serving cell may transmit a TA command to the UE, wherein the TA command may include a TA value and a next preamble index. In one example, the serving cell may further transmit an indication, wherein the indication may indicate that the RACH preamble corresponding to the next preamble index will be used in the N-th subsequent RACH (or PRACH) occasion after the TA value (or the next preamble index) is received by the UE, where N is a positive integer. The UE may store the TA value, the next preamble index, and the indication. The TA command can be received by the UE after the TA timer expires (e.g., previous acquired TA (e.g., TA value in step S202-3) becomes invalid). After the TA timer expires, RACH-less cell switch will be no longer achievable without TA update.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a random access (RA) procedure, and consider the RACH-based cell switch to be ongoing.

In one example, the UE may transmit the TA re-acquisition message to the candidate cell at the latest RACH occasion (RO) or the latest PRACH occasion before the TA timer expires (or at a time offset before the TA timer expires, wherein the time offset may be less than a threshold). That is, the UE may use the RACH preamble at the latest RACH (or PRACH) occasion before the TA timer expires. For example, step S202-1 can be executed at the latest RACH occasion before the TA timer expires in step S204. In this case, the serving cell may not transmit the indication through the TA command (e.g., TA command in step S201, S202-3 or S203-3).

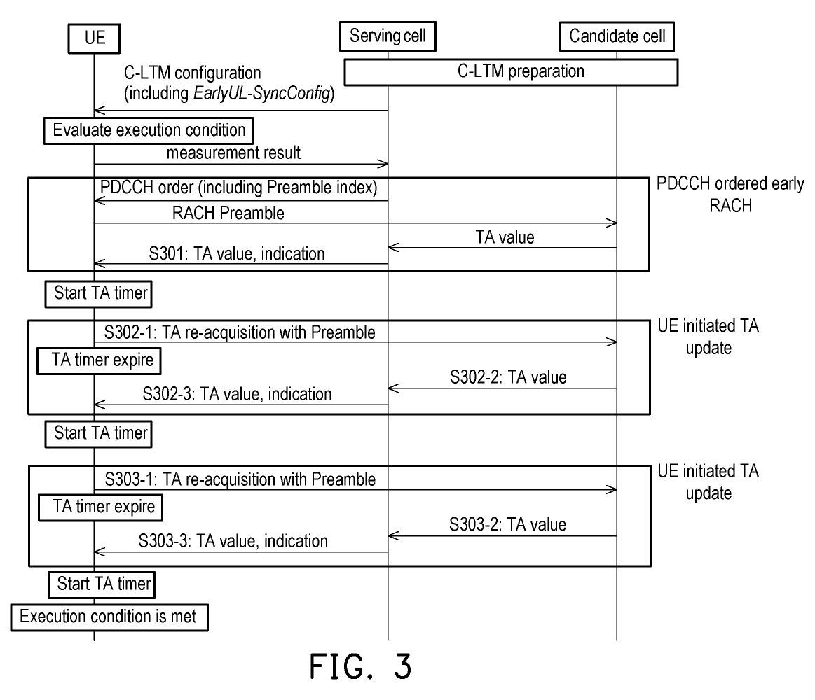

In order to prevent occupation of the preamble and avoid wasting communication resources, in one example, the preamble index may be provided to the UE only once. FIG. 3 illustrates a signaling diagram of TA value update initiated by the UE according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S301, the serving cell may transmit the TA value and an indication to the UE, wherein the indication may indicate that the RACH preamble corresponding to the preamble index (e.g., preamble index received from the PDCCH order) will be used on the N-th subsequent RACH (or PRACH) occasion after the TA value is received by the UE, where N is a positive integer. The UE may store the TA value and the indication.

After the UE starts the TA timer corresponding to the TA value (e.g., TA value provided in step S301), the UE may initiate TA update. Specifically, in step S302-1, the UE may transmit a TA re-acquisition message with the preamble (e.g., preamble corresponding to the preamble index provided via the PDCCH order) to the candidate cell. In step S302-2, in response to the RACH preamble, the candidate cell may transmit a TA value to the serving cell. In step S302-3, the serving cell may transmit a TA command to the UE, wherein the TA command may include a TA value and an indication, wherein the indication may indicate that the RACH preamble corresponding to the preamble index (e.g., preamble index provided via the PDCCH order) will be used on the N-th subsequent RACH (or PRACH) occasion after the TA value is received by the UE, where N is a positive integer. The UE may store the TA value and the indication. The TA command can be received by the UE after the TA timer expires (e.g., previous acquired TA (e.g., TA value in step S301) becomes invalid). After the TA timer expires, RACH-less cell switch will be no longer achievable without TA update.

After the UE starts the TA timer corresponding to the TA value (e.g., TA value provided in step S302-3), the UE may initiate TA update. Specifically, in step S303-1, the UE may transmit a TA re-acquisition message with the preamble (e.g., preamble corresponding to the preamble index provided via the PDCCH order) to the candidate cell. In step S303-2, in response to the RACH preamble, the candidate cell may transmit a TA value to the serving cell. In step S303-3, the serving cell may transmit a TA command to the UE, wherein the TA command may include a TA value and an indication, wherein the indication may indicate that the RACH preamble corresponding to the preamble index (e.g., preamble index provided via the PDCCH order) will be used on the N-th subsequent RACH (or PRACH) occasion after the TA value is received by the UE, where N is a positive integer. The UE may store the TA value and the indication. The TA command can be received by the UE after the TA timer expires (e.g., previous acquired TA (e.g., TA value in step S302-3) becomes invalid). After the TA timer expires, RACH-less cell switch will be no longer achievable without TA update.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

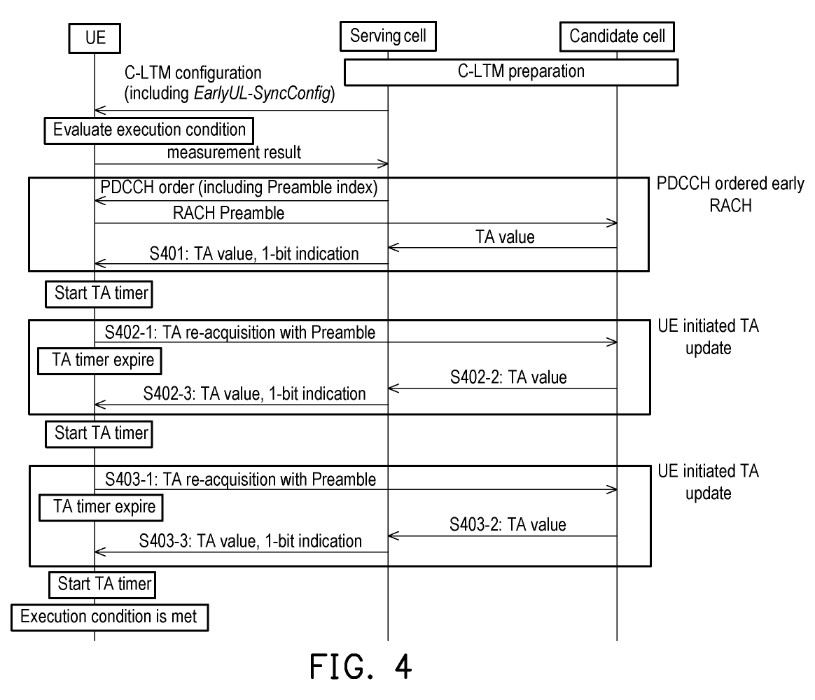

FIG. 4 illustrates a signaling diagram of TA value update initiated by the UE according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S401, the serving cell may transmit the TA value and an indication (e.g., 1-bit indication) to the UE, wherein the indication may indicate whether to perform TA update. The UE may store the TA value and the 1-bit indication.

After the UE starts the TA timer corresponding to the TA value (e.g., TA value provided in step S401), if the 1-bit indication indicates that the UE is to perform TA update, the UE may initiate the TA update prior to expiration of the TA timer. Specifically, in step S402-1, the UE may transmit a TA re-acquisition message with a second RACH preamble to the candidate cell, wherein the second RACH preamble is pre-configured to the UE. For example, the second RACH preamble may be hard-coded in a communication specification. The second RACH preamble is to be used in a RACH (or PRACH) occasion prior to expiration of the TA timer. For example, the second RACH preamble is to be used in a latest available RACH (or PRACH) occasion prior to expiration of the TA timer. In step S402-2, in response to the second RACH preamble, the candidate cell may transmit a TA value to the serving cell. In step S402-3, the serving cell may transmit a TA command to the UE, wherein the TA command may include a TA value and an indication (e.g., 1-bit indication), wherein the indication may indicate whether to perform TA update. The UE may store the TA value and the 1-bit indication. The TA command can be received by the UE after the TA timer expires (e.g., previous acquired TA (e.g., TA value in step S401) becomes invalid). After the TA timer expires, RACH-less cell switch will be no longer achievable without TA update.

After the UE starts the TA timer corresponding to the TA value (e.g., TA value provided in step S402-3), if the 1-bit indication indicates that the UE is to perform TA update, the UE may initiate the TA update. Specifically, in step S403-1, the UE may transmit a TA re-acquisition message with the second RACH preamble to the candidate cell. In step S403-2, in response to the second RACH preamble, the candidate cell may transmit a TA value to the serving cell. In step S403-3, the serving cell may transmit a TA command to the UE, wherein the TA command may include a TA value and an indication (e.g., 1-bit indication), wherein the indication may indicate whether to perform TA update. The UE may store the TA value and the 1-bit indication. The TA command can be received by the UE after the TA timer expires (e.g., previous acquired TA (e.g., TA value in step S402-3) becomes invalid). After the TA timer expires, RACH-less cell switch will be no longer achievable without TA update.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

In one example, the using time of the pre-configured preamble is hard-coded in the communication specification.

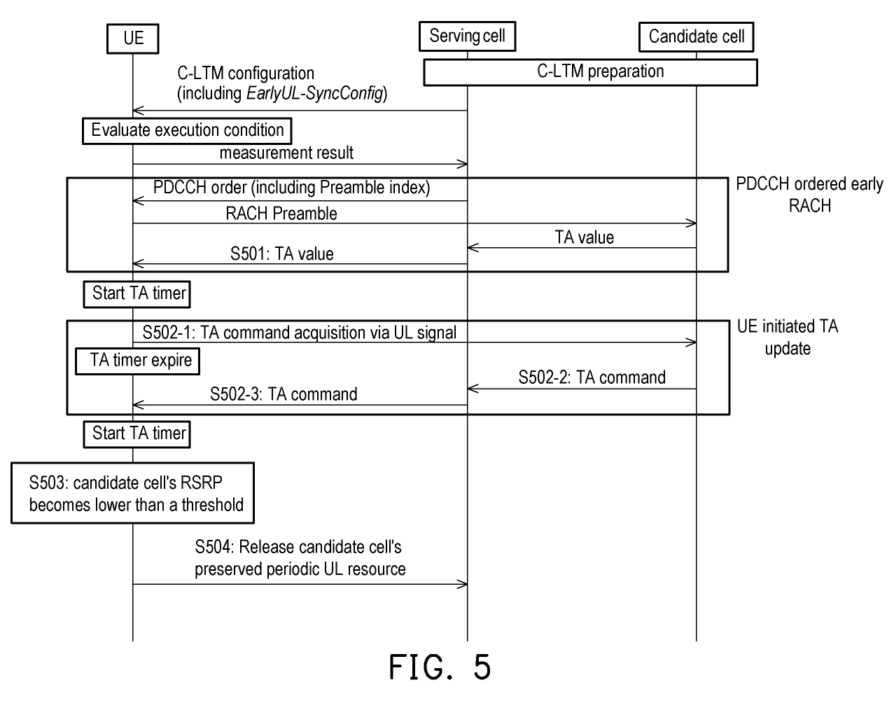

The validity of a TA value can be maintained by the candidate cell when sufficient UL transmission resources are available between the UE and the candidate cell. FIG. 5 illustrates a signaling diagram of TA value update initiated by the UE according to one embodiment of the present disclosure. The C-LTM configuration received by the UE may include candidate cell’s preserved periodic UL resources (e.g., configured grant (CG) or physical uplink control channel (PUCCH)). The UL resources can be activated upon TA acquisition/re-acquisition due to PDCCH ordered early RACH.

The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S501, the serving cell may transmit the TA value to the UE. After the UE starts the TA timer corresponding to the TA value (e.g., TA value provided in step S501), the UE may initiate TA update. Specifically, if the capacity is allowed, in step S502-1, the UE may transmit a TA command acquisition message with an UL signal for synchronization to the candidate cell, wherein the TA command acquisition message or the UL signal may be transmitted via the preserved periodic UL resources (e.g., PUCCH). The UE may store the TA value.

In step S502-2, in response to the TA command acquisition message, the candidate cell may transmit a TA command to the serving cell, wherein the TA command may include an adjustment value of TA. In step S502-3, the serving cell may transmit the TA command to the UE. The UE may store the TA command. The UE may adjust the TA value (e.g., TA value received in step S501) according to the TA command. After the UE starts the TA timer according to the adjusted TA value, in step S503, the UE may detect the candidate cell’s reference signal received power (RSRP) and determine whether the RSRP becomes lower than a threshold. If the RSRP becomes lower than the threshold, the UE may determine that the candidate cell is no longer a target cell for cell switching. Accordingly, in step S504, the UE may deactivate/release candidate cell’s preserved periodic UL resource.

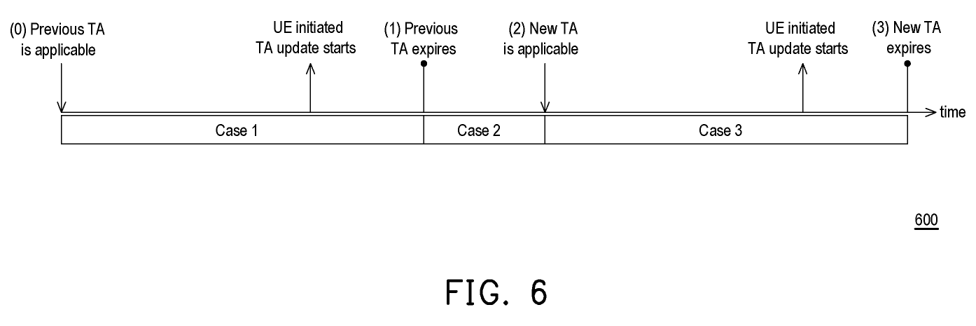

FIG. 6 illustrates a schematic diagram 600 of UE behaviour when C-LTM execution condition is met according to one embodiment of the present disclosure. Case 1: if a C-LTM execution condition is met between (0) previous TA is applicable and (1) previous TA expires, the UE may immediately perform RACH-less cell switch (and stop the on-going TA update, if any) upon execution condition fulfillment by using the previous TA (e.g., old TA), wherein a UE initiated TA update can be started between (0) previous TA is applicable and (1) previous TA expires. Case 2: if a C-LTM execution condition is met between (1) previous TA expires and (2) new TA is applicable, the UE may defer the cell switch until the new TA is applicable (UE continues the on-going TA update). The UE may perform RACH-less cell switch by using the new TA upon the new TA is applicable. Case 3: if a C-LTM execution condition is met between (2) New TA is applicable and (3) New TA expires, the UE may immediately perform RACH-less cell switch (and stop the on-going TA update, if any) upon execution condition fulfillment by using the new TA, wherein a UE initiated TA update can be started between (2) New TA is applicable and (3) New TA expires.

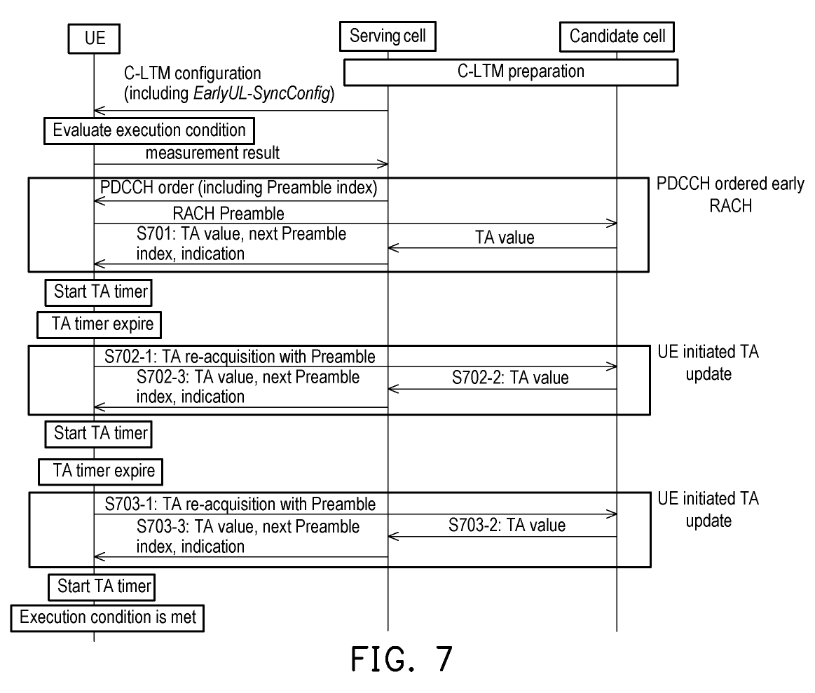

In one example, the UE may re-acquire (or update) a new TA after previous TA value expires by using the preamble provided via previous TA acquisition/re-acquisition procedure. That is, the TA update can be initiate if the current TA value configured to the UE becomes invalid. FIG. 7 illustrates a signaling diagram of TA value update initiated by the UE according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S701, the serving cell may transmit a TA value, a next preamble index, and an indication to the UE, wherein the indication may indicate that the RACH preamble corresponding to the next preamble index will be used in the N-th subsequent RACH (or PRACH) occasion after the TA value (or the next preamble value) is received by the UE, where N is a positive integer. The UE may store the TA value, the next preamble index, and the indication.

The UE may start the TA timer corresponding to the TA value (e.g., TA value provided in step S701). After the TA timer expires, RACH-less cell switch will be no longer achievable without TA update. In step S702-1, the UE may transmit a TA re-acquisition message with the preamble (e.g., preamble corresponding to the preamble index provided via previous TA acquisition or TA re-acquisition, for example, preamble corresponding to the next preamble index provided in step S701) to the candidate cell. In step S702-2, in response to the RACH preamble, the candidate cell may transmit a TA value to the serving cell. In step S702-3, the serving cell may transmit a TA command to the UE, wherein the TA command may include a TA value, a next preamble index, and an indication, wherein the indication may indicate that the RACH preamble corresponding to the next preamble index will be used in the N-th subsequent RACH (or PRACH) occasion after the TA value (or the next preamble index) is received by the UE, where N is a positive integer. The UE may store the TA value, the next preamble index, and the indication. After the TA timer expires, RACH-less cell switch will be no longer achievable without TA update.

The UE may start the TA timer corresponding to the TA value (e.g., TA value provided in step S702-3). After the TA timer expires, RACH-less cell switch will be no longer achievable without TA update. in step S703-1, the UE may transmit a TA re-acquisition message with the preamble (e.g., preamble corresponding to the preamble index provided via previous TA acquisition or TA re-acquisition, for example, preamble corresponding to the next preamble index provided in step S702-3) to the candidate cell. In step S703-2, in response to the RACH preamble, the candidate cell may transmit a TA value to the serving cell. In step S703-3, the serving cell may transmit a TA command to the UE, wherein the TA command may include a TA value, a next preamble index, and an indication, wherein the indication may indicate that the RACH preamble corresponding to the next preamble index will be used in the N-th subsequent RACH (or PRACH) occasion after the TA value (or the next preamble index) is received by the UE, where N is a positive integer. The UE may store the TA value, the next preamble index, and the indication. After the TA timer expires, RACH-less cell switch will be no longer achievable without TA update.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

In one example, if delivery of a TA value between the candidate cell and the serving cell results in a change in a validity period of the TA value, the TA value transmitted to the UE should be guaranteed by the network.

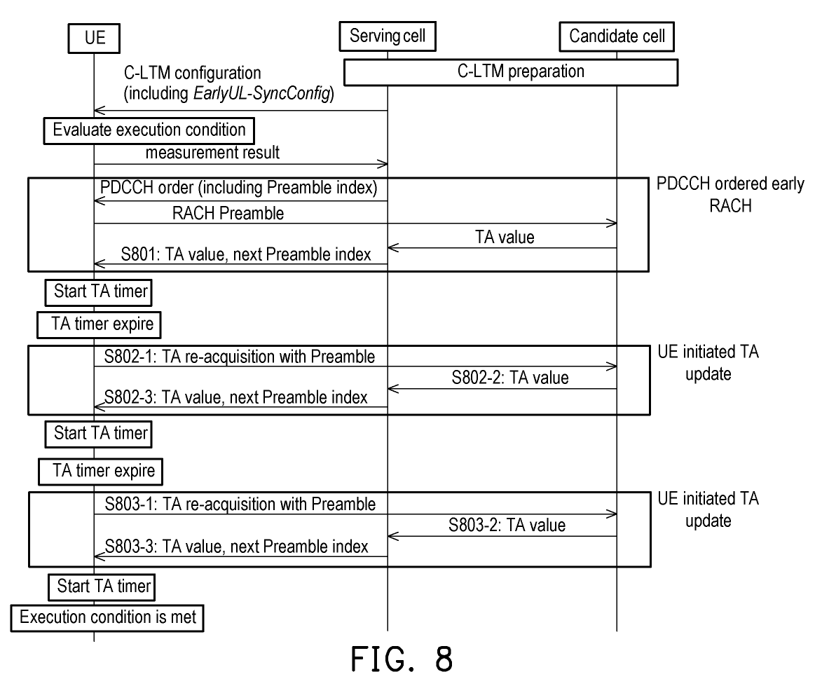

FIG. 8 illustrates a signaling diagram of TA value update initiated by the UE according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S801, the serving cell may transmit a TA value and a next preamble index to the UE. The RACH preamble corresponding to the next preamble index will be used after the TA timer expires. For example, the RACH preamble corresponding to the next preamble index will be used in the first available RO after the TA timer expires. The UE may store the TA value and the next preamble index. The UE may start the TA timer corresponding to the TA value.

After the TA timer expires, the previous acquired TA value (e.g., TA value acquired in step S801) becomes invalid, and the RACH-less cell switch will be no-longer achievable without TA update. In step S802-1, the UE may transmit a TA re-acquisition message with the preamble (e.g., preamble corresponding to the preamble index provided via previous TA acquisition/re- acquisition, for example, preamble corresponding to the next preamble index provided in step S801) to the candidate cell. In step S802-2, in response to the RACH preamble, the candidate cell may transmit a TA value to the serving cell. In step S802-3, the serving cell may transmit a TA command to the UE, wherein the TA command may include a TA value and a next preamble index. The RACH preamble corresponding to the next preamble index will be used after the TA timer expires. For example, the RACH preamble corresponding to the next preamble index will be used in the first available RO after the TA timer expires. The UE may store the TA value and the next preamble index. The UE may start the TA timer corresponding to the TA value.

After the TA timer expires, the previous acquired TA value (e.g., TA value acquired in step S802-3) becomes invalid, and the RACH-less cell switch will be no-longer achievable without TA update. In step S803-1, the UE may transmit a TA re-acquisition message with the preamble (e.g., preamble corresponding to the preamble index provided via previous TA acquisition/re- acquisition, for example, preamble corresponding to the next preamble index provided in step S802-3) to the candidate cell. In step S803-2, in response to the RACH preamble, the candidate cell may transmit a TA value to the serving cell. In step S803-3, the serving cell may transmit a TA command to the UE, wherein the TA command may include a TA value and a next preamble index. The RACH preamble corresponding to the next preamble index will be used after the TA timer expires. For example, the RACH preamble corresponding to the next preamble index will be used in the first available RO after the TA timer expires. The UE may store the TA value and the next preamble index. The UE may start the TA timer corresponding to the TA value.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

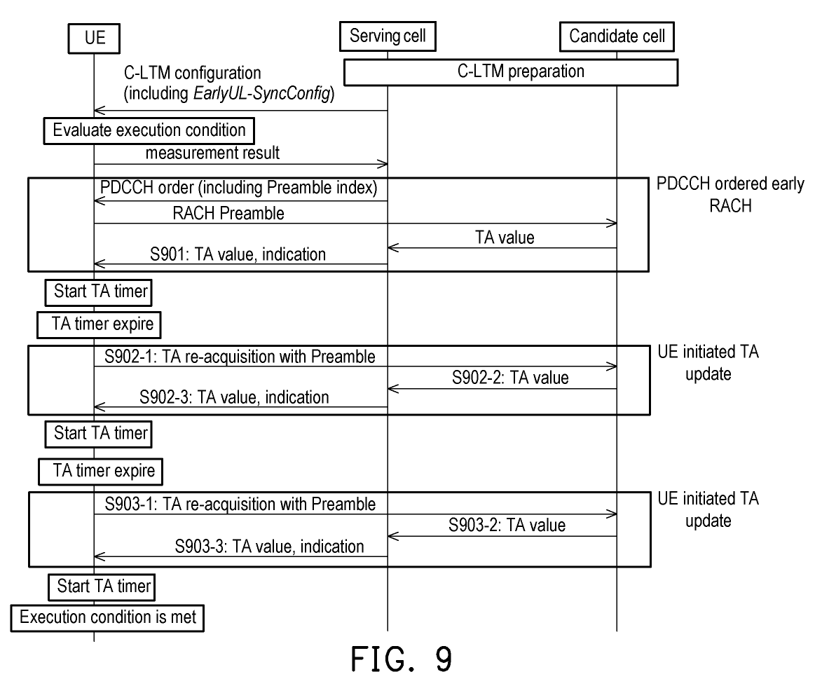

In one example, the preamble index may be provided to the UE only once. FIG. 9 illustrates a signaling diagram of TA value update initiated by the UE according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S901, the serving cell may transmit a TA value and an indication to the UE, wherein the indication may indicate that the RACH preamble corresponding to the preamble index (e.g., preamble index received from the PDCCH order) will be used in the N-th subsequent RACH (or PRACH) occasion after the TA value is received by the UE, where N is a positive integer. The UE may store the TA value and the indication.

The UE may start the TA timer corresponding to the TA value (e.g., TA value provided in step S901). After the TA timer expires, RACH-less cell switch will be no longer achievable without TA update. In step S902-1, the UE may transmit a TA re-acquisition message with the preamble (e.g., preamble index received from the PDCCH order) to the candidate cell. In step S902-2, in response to the RACH preamble, the candidate cell may transmit a TA value to the serving cell. In step S902-3, the serving cell may transmit a TA command to the UE, wherein the TA command may include a TA value and an indication, wherein the indication may indicate that the RACH preamble corresponding to the preamble index (e.g., preamble index received from the PDCCH order) will be used in the N-th subsequent RACH (or PRACH) occasion after the TA value is received by the UE, where N is a positive integer. The UE may store the TA value and the indication.

The UE may start the TA timer corresponding to the TA value (e.g., TA value provided in step S902-3). After the TA timer expires, RACH-less cell switch will be no longer achievable without TA update. In step S903-1, the UE may transmit a TA re-acquisition message with the preamble (e.g., preamble index received from the PDCCH order) to the candidate cell. In step S903-2, in response to the RACH preamble, the candidate cell may transmit a TA value to the serving cell. In step S903-3, the serving cell may transmit a TA command to the UE, wherein the TA command may include a TA value and an indication, wherein the indication may indicate that the RACH preamble corresponding to the preamble index (e.g., preamble index received from the PDCCH order) will be used in the N-th subsequent RACH (or PRACH) occasion after the TA value is received by the UE, where N is a positive integer. The UE may store the TA value and the indication. The UE may start the TA timer corresponding to the TA value.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

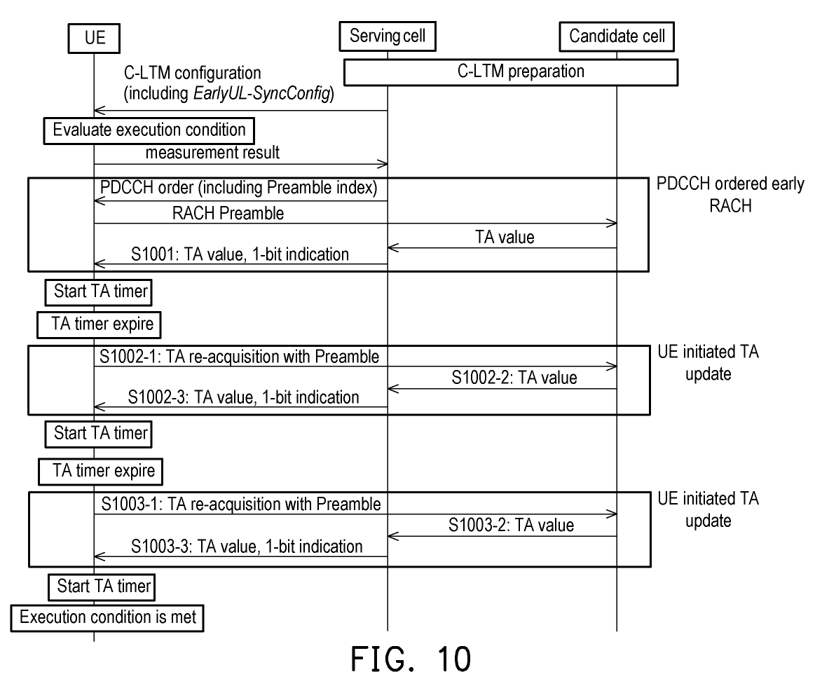

FIG. 10 illustrates a signaling diagram of TA value update initiated by the UE according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S1001, the serving cell may transmit the TA value and an indication (e.g., 1-bit indication) to the UE, wherein the indication may indicate whether to perform TA update. The UE may store the TA value and the 1-bit indication.

The UE may start the TA timer corresponding to the TA value (e.g., TA value provided in step S1001). After the TA timer expires, RACH-less cell switch will be no longer achievable without TA update. If the 1-bit indication indicates that the UE is to perform TA update, the UE may initiate the TA update after the TA timer expires. Specifically, in step S1002-1, the UE may transmit a TA re-acquisition message with a second RACH preamble to the candidate cell, wherein the second RACH preamble is pre-configured to the UE. For example, the second RACH preamble may be hard-coded in a communication specification. The second RACH preamble will be used after the TA timer expires. For example, the second RACH preamble will be used in the first available RACH (or PRACH) occasion after the TA timer expires. In step S1002-2, in response to the second RACH preamble, the candidate cell may transmit a TA value to the serving cell. In step S1002-3, the serving cell may transmit a TA command to the UE, wherein the TA command may include a TA value and an indication (e.g., 1-bit indication), wherein the indication may indicate whether to perform TA update. The UE may store the TA value and the 1-bit indication.

The UE may start the TA timer corresponding to the TA value (e.g., TA value provided in step S1002-3). After the TA timer expires, RACH-less cell switch will be no longer achievable without TA update. If the 1-bit indication indicates that the UE is to perform TA update, the UE may initiate the TA update after the TA timer expires. Specifically, in step S1003-1, the UE may transmit a TA re-acquisition message with the second RACH preamble to the candidate cell. In step S1003-2, in response to the second RACH preamble, the candidate cell may transmit a TA value to the serving cell. In step S1003-3, the serving cell may transmit a TA command to the UE, wherein the TA command may include a TA value and an indication (e.g., 1-bit indication), wherein the indication may indicate whether to perform TA update. The UE may store the TA value and the 1-bit indication. The UE may start the TA timer corresponding to the TA value.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

In one example, the using time of the pre-configured preamble is hard-coded in the communication specification.

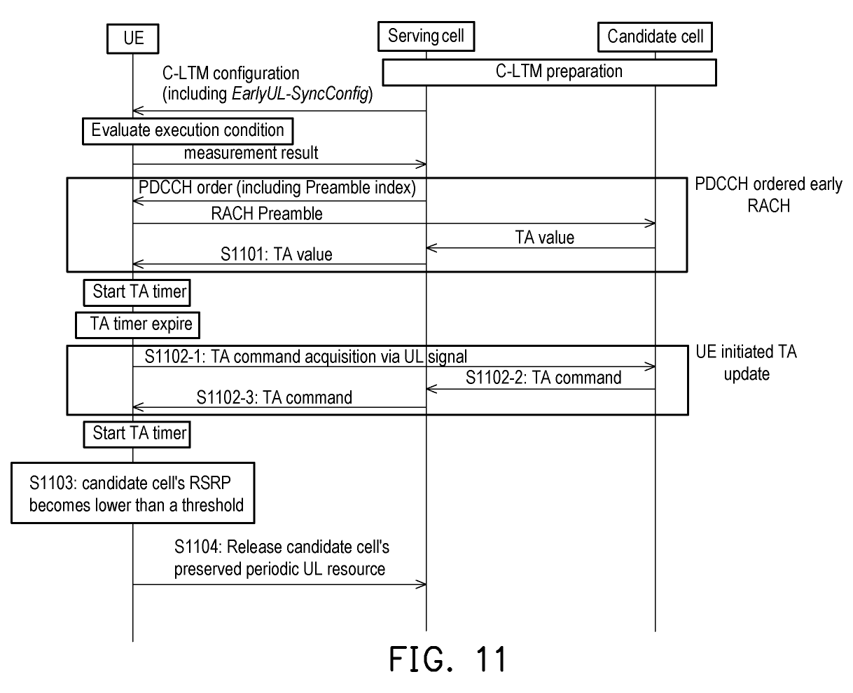

The validity of a TA value can be maintained by the candidate cell when sufficient UL transmission resources are available between the UE and the candidate cell. FIG. 11 illustrates a signaling diagram of TA value update initiated by the UE according to one embodiment of the present disclosure. The C-LTM configuration received by the UE may include candidate cell’s preserved periodic UL resources (e.g., CG or PUCCH). The UL resources can be activated upon TA acquisition/re-acquisition due to PDCCH ordered early RACH.

The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S1101, the serving cell may transmit the TA value to the UE. The UE may store the TA value.

The UE may start the TA timer corresponding to the TA value (e.g., TA value provided in step S1101). After the TA timer expires, RACH-less cell switch will be no longer achievable without TA update. The UE may initiate the TA update after the TA timer expires. Specifically, if the capacity is allowed, in step S1102-1, the UE may transmit a TA command acquisition message with an UL signal for synchronization to the candidate cell, wherein the TA command acquisition message or the UL signal may be transmitted via the preserved periodic UL resources (e.g., PUCCH). The UE may store the TA value.

In step S1102-2, in response to the TA command acquisition message, the candidate cell may transmit a TA command to the serving cell, wherein the TA command may include an adjustment value of TA. In step S1102-3, the serving cell may transmit the TA command to the UE. The UE may store the TA command. The UE may adjust the TA value (e.g., TA value received in step S1101) according to the TA command. After the UE starts the TA timer according to the adjusted TA value, in step S1103, the UE may detect the candidate cell’s reference signal received power (RSRP) and determine whether the RSRP becomes lower than a threshold. If the RSRP becomes lower than the threshold, the UE may determine that the candidate cell is no longer a target cell for cell switching. Accordingly, in step S1104, the UE may deactivate/release candidate cell’s preserved periodic UL resource.

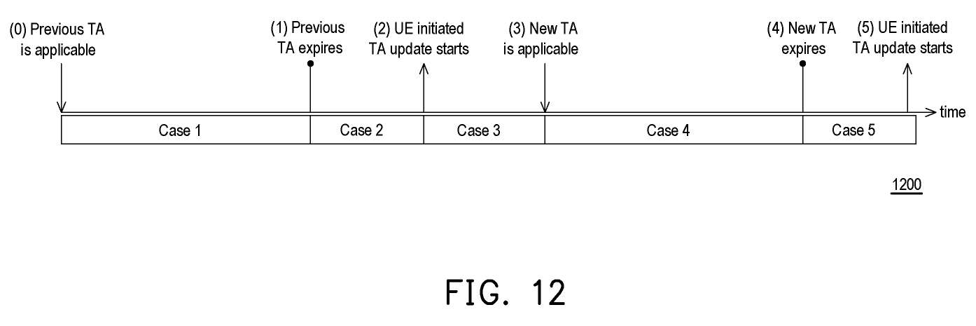

FIG. 12 illustrates a schematic diagram 1200 of UE behaviour when C-LTM execution condition is met according to one embodiment of the present disclosure. Case 1: if a C-LTM execution condition is met between (0) previous TA is applicable and (1) previous TA expires, the UE may immediately perform RACH-less cell switch (and stop the on-going TA update, if any) upon execution condition fulfillment by using the previous TA (e.g., old TA). Case 2: if a C-LTM execution condition is met between (1) previous TA expires and (2) UE initiated TA update starts, the UE may immediately perform RACH-based cell switch upon execution condition fulfillment. Case 3: if a C-LTM execution condition is met between (2) UE initiated TA update starts and (3) new TA is applicable, the UE may defer the cell switch until the new TA is applicable (UE continues the on-going TA update). The UE may perform RACH-less cell switch by using the new TA upon the new TA is applicable. Case 4: if a C-LTM execution condition is met between (3) new TA is applicable and (4) new TA expires, the UE may immediately perform RACH-less cell switch upon execution condition fulfillment by using the new TA. Case 5: if a C-LTM execution condition is met between (4) new TA expires and (5) UE initiated TA update starts, the UE may immediately perform RACH-based cell switch upon execution condition fulfillment.

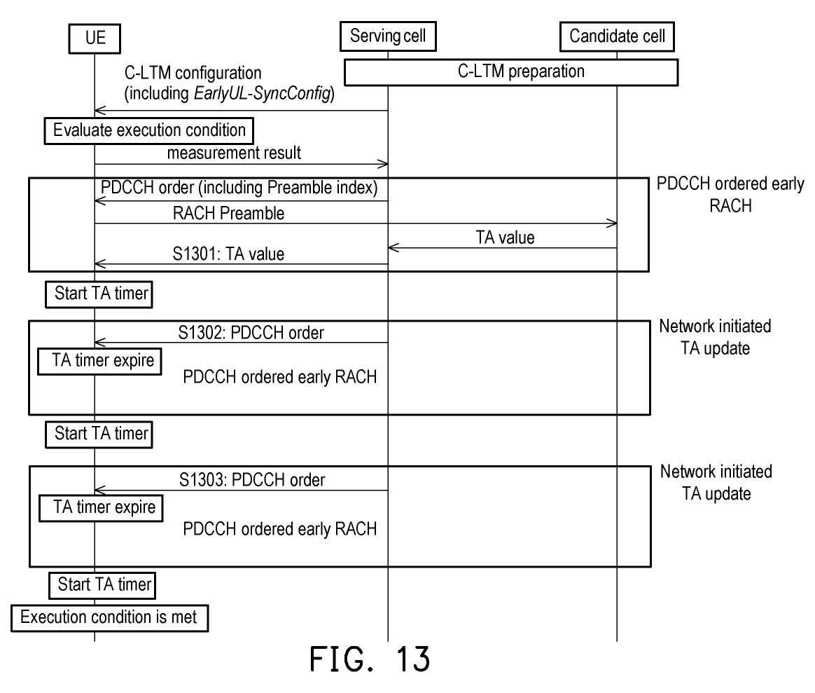

In one example, the TA update can be initiated by the network. FIG. 13 illustrates a signaling diagram of TA value update initiated by the network according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The serving cell may determine whether to trigger a PDCCH ordered early RACH based on the measurement result. In response to determining to trigger the PDCCH ordered early RACH , the serving cell may transmit a PDCCH order to the UE. The UE may receive the PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S1301, the serving cell may transmit the TA value to the UE. The UE may store the TA value. The UE may start the TA timer corresponding to the TA value.

The network may initiate a second PDCCH ordered early RACH to trigger TA update when the previous TA value (or TA timer) is about to expire (e.g., the remaining time of the TA timer becomes less than a threshold). Specifically, in step S1302, the serving cell may trigger the second PDCCH ordered early RACH by transmitting a second PDCCH order to the UE, wherein the second PDCCH order may include a preamble index. After the TA timer expires, the previously acquired TA (e.g., TA acquired in step S1301) will be no longer valid. The UE may re-acquire a TA value by transmitting a RACH preamble corresponding to the preamble index to the candidate cell. In response to the RACH preamble, the candidate cell may transmit an updated TA value to the serving cell.

After the serving cell receiving the updated TA value from the candidate cell, the serving cell may transmit the updated TA value to the UE. The UE may store the updated TA value. The UE may start the TA timer corresponding to the updated TA value.

The network may initiate a third PDCCH ordered early RACH to trigger TA update when the previous TA value (or TA timer) is about to expire. Specifically, in step S1303, the serving cell may trigger the third PDCCH ordered early RACH by transmitting a third PDCCH order to the UE, wherein the third PDCCH order may include a preamble index. After the TA timer expires, the previously acquired TA (e.g., TA re-acquired based on the second PDCCH order transmitted in step S1302) will be no longer valid. The UE may re-acquire a TA value by transmitting a RACH preamble corresponding to the preamble index to the candidate cell. In response to the RACH preamble, the candidate cell may transmit an updated TA value to the serving cell.

After the serving cell receiving the updated TA value from the candidate cell, the serving cell may transmit the updated TA value to the UE. The UE may store the updated TA value. The UE may start the TA timer corresponding to the updated TA value.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

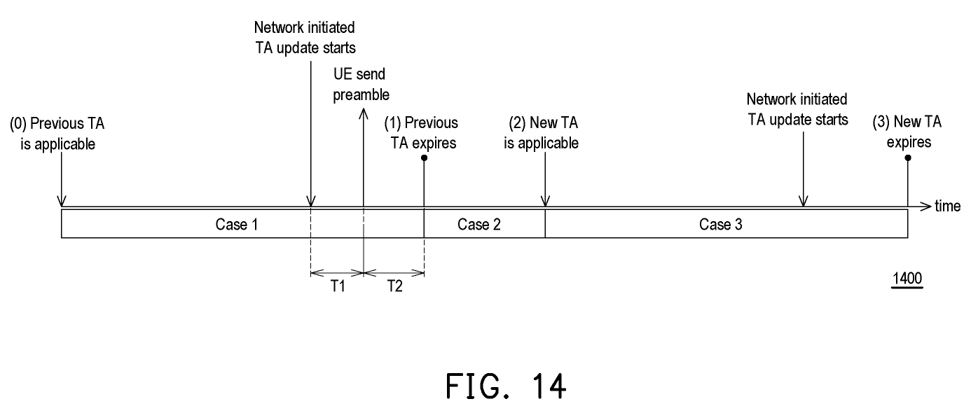

FIG. 14 illustrates a schematic diagram 1400 of UE behaviour when C-LTM execution condition is met according to one embodiment of the present disclosure. Case 1: if a C-LTM execution condition is met between (0) previous TA is applicable and (1) previous TA expires, the UE may immediately perform RACH-less cell switch (and stop the on-going TA update, if any) upon execution condition fulfillment by using the previous TA (e.g., old TA), wherein a network initiated TA update can be started between (0) previous TA is applicable and (1) previous TA expires. Case 2: if a C-LTM execution condition is met between (1) previous TA expires and (2) new TA is applicable, the UE may defer the cell switch until the new TA is applicable (UE continues the on-going TA update). The UE may perform RACH-less cell switch by using the new TA upon the new TA is applicable. Case 3: if a C-LTM execution condition is met between (2) New TA is applicable and (3) New TA expires, the UE may immediately perform RACH-less cell switch (and stop the on-going TA update, if any) upon execution condition fulfillment by using the new TA, wherein a network initiated TA update can be started between (2) New TA is applicable and (3) New TA expires.

In one example, the UE may send a preamble (e.g., preamble corresponding to the preamble index provided by the PDCCH order) to the serving cell. If the cell switch is performed before the preamble is sent (e.g., time period T1), the UE may not send the preamble due to configuration change (the on-going TA update is stopped). If the cell switch is performed after the preamble is sent (e.g., time period T2), the UE may not receive the updated TA due to disconnection with the serving cell (the on-going TA update is stopped).

In one example, the network may initiate TA update, UE may re-acquire (or update) a new TA after previous TA value expires. That is, the TA update can be initiate if the current TA value configured to the UE becomes invalid.

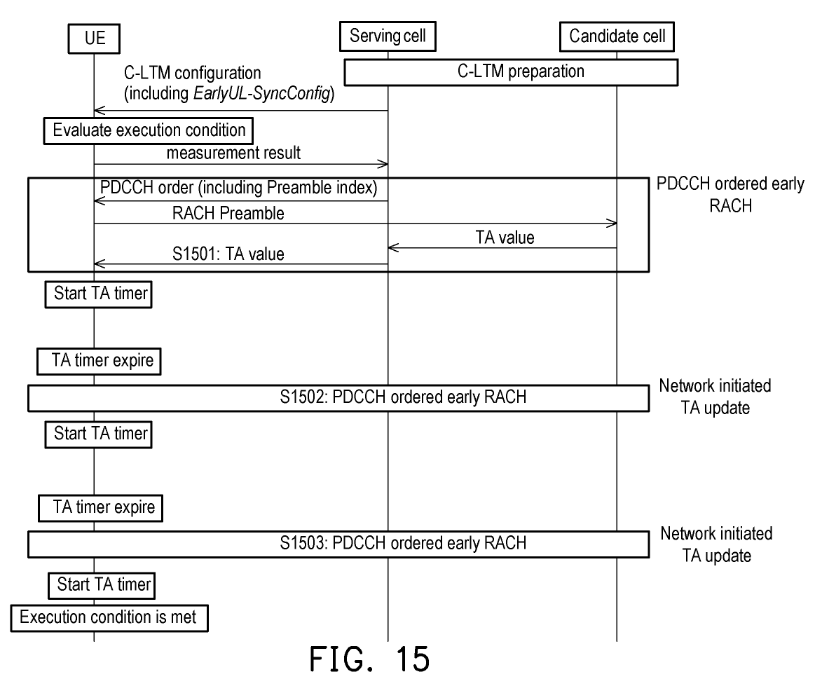

FIG. 15 illustrates a signaling diagram of TA value update initiated by the network according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The serving cell may determine whether to trigger a PDCCH ordered early RACH based on the measurement result. In response to determining to trigger the PDCCH ordered early RACH, the serving cell may transmit a PDCCH order to the UE. The UE may receive the PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S1501, the serving cell may transmit the TA value to the UE. The UE may store the TA value. The UE may start the TA timer corresponding to the TA value. After the TA timer expires, the previously acquired TA (e.g., TA acquired in step S1501) will be no longer valid.

The network may initiate a second PDCCH ordered early RACH to trigger TA update after the previous TA value (or TA timer) expires. Specifically, in step S1502, the serving cell may trigger the second PDCCH ordered early RACH by transmitting a second PDCCH order to the UE, wherein the second PDCCH order may include a preamble index. The UE may re-acquire a TA value by transmitting a RACH preamble corresponding to the preamble index to the candidate cell. In response to the RACH preamble, the candidate cell may transmit an updated TA value to the serving cell.

After the serving cell receiving the updated TA value from the candidate cell, the serving cell may transmit the updated TA value to the UE. The UE may store the updated TA value. The UE may start the TA timer corresponding to the updated TA value.

After the TA timer expires, the previously acquired TA (e.g., TA acquired in step S1502) will be no longer valid. The network may initiate a third PDCCH ordered early RACH to trigger TA update after the previous TA value (or TA timer) expires. Specifically, in step S1503, after the previous TA value expires, the serving cell may trigger the third PDCCH ordered early RACH by transmitting a third PDCCH order to the UE, wherein the third PDCCH order may include a preamble index. The UE may re-acquire a TA value by transmitting a RACH preamble corresponding to the preamble index to the candidate cell. In response to the RACH preamble, the candidate cell may transmit an updated TA value to the serving cell.

After the serving cell receiving the updated TA value from the candidate cell, the serving cell may transmit the updated TA value to the UE. The UE may store the updated TA value. The UE may start the TA timer corresponding to the updated TA value.

If an execution condition is met while the TA timer is running (i.e., TA value is valid), the UE may perform a RACH-less cell switch based on the valid TA value. If the execution condition is met after the TA timer expires and the TA value is not updated, the UE may perform a RACH-based cell switch. Specifically, the UE may initiate a RA procedure, and consider the RACH-based cell switch to be ongoing.

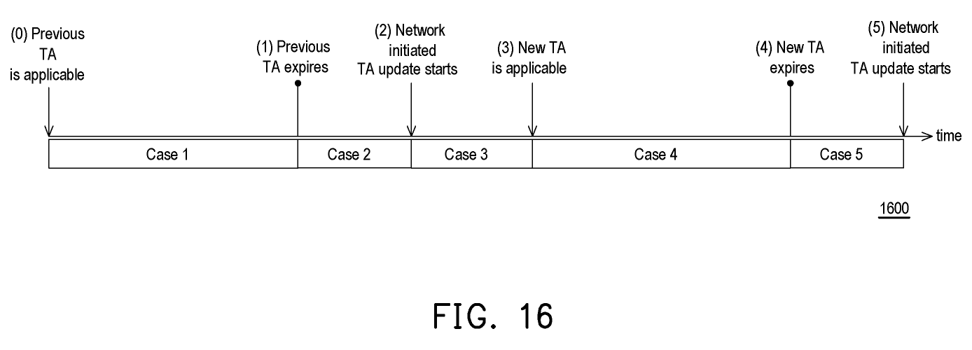

FIG. 16 illustrates a schematic diagram 1600 of UE behaviour when C-LTM execution condition is met according to one embodiment of the present disclosure. Case 1: if a C-LTM execution condition is met between (0) previous TA is applicable and (1) previous TA expires, the UE may immediately perform RACH-less cell switch upon execution condition fulfillment by using the previous TA (e.g., old TA). Case 2: if a C-LTM execution condition is met between (1) previous TA expires and (2) network initiated TA update starts, the UE may immediately perform RACH-based cell switch upon execution condition fulfillment. Case 3: if a C-LTM execution condition is met between (2) network initiated TA update starts and (3) new TA is applicable, the UE may defer the cell switch until the new TA is applicable (UE continues the on-going TA update). The UE may perform RACH-less cell switch by using the new TA upon the new TA is applicable. Case 4: if a C-LTM execution condition is met between (3) new TA is applicable and (4) new TA expires, the UE may immediately perform RACH-less cell switch upon execution condition fulfillment by using the new TA. Case 5: if a C-LTM execution condition is met between (4) new TA expires and (5) network initiated TA update starts, the UE may immediately perform RACH-based cell switch upon execution condition fulfillment.

In one example, the UE may perform RACH-based cell switch (or perform failure handling of TA update) since the TA update may fail. For example, if the serving cell’s link quality deteriorates, the candidate TA (e.g., TA of the candidate cell) might not be successfully delivered to the UE. Alternatively, if the serving cell’s quality is very poor and a cell switch must be performed quickly to maintain the connection, a RACH-based approach can be adopted to obtain the TA during the cell switch execution.

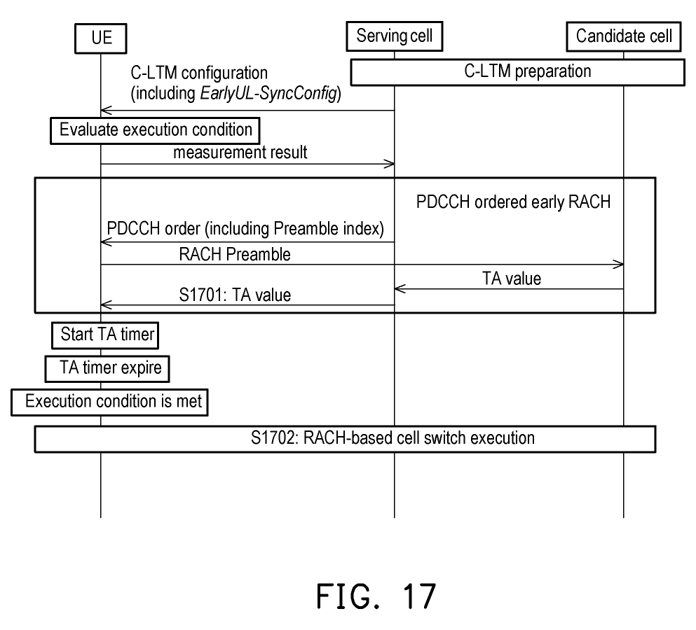

FIG. 17 illustrates a signaling diagram of TA value update according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S1701, the serving cell may transmit the TA value to the UE. The UE may store the TA value. The UE may start the TA timer corresponding to the TA value. If the execution condition is met after the TA timer expires and the TA value is not able to be updated (successfully) (e.g., due to link quality between the UE and the serving cell degradation), in step S1702, the UE may perform a RACH-based cell switch execution. Specifically, the UE may initiate a RA procedure, and consider the RACH-based cell switch to be ongoing.

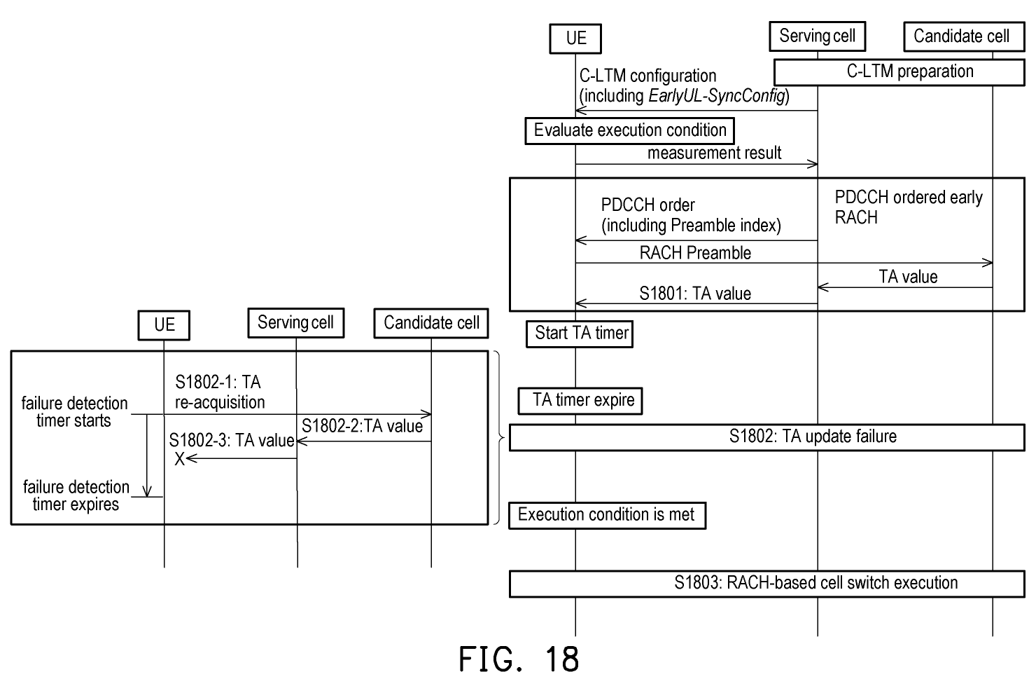

FIG. 18 illustrates a signaling diagram of TA value update according to one embodiment of the present disclosure. The serving cell and the candidate cell may perform C-LTM preparation. The serving cell may transmit a cell switch configuration to the UE, wherein the cell switch configuration may include a C-LTM configuration including EarlyUL-SynConfig. The C-LTM configuration may include one or more candidate cell configurations. The C-LTM configuration may further include one or more execution conditions. The UE may evaluate the execution conditions in the cell switch configuration, wherein each one of the execution conditions may be associated with each one of the candidate cell configurations. The UE may report the measurement result to the serving cell. The UE may receive a PDCCH order including a preamble index from the serving cell, and the UE may transmit the RACH preamble corresponding to the preamble index to the candidate cell. In response to the RACH preamble, the candidate cell may transmit a TA value to the serving cell.

After the serving cell receiving the TA value from the candidate cell, in step S1801, the serving cell may transmit the TA value to the UE. The UE may store the TA value. The UE may start the TA timer corresponding to the TA value. After the TA timer expires, in step S1802, the UE or the network may initiate TA update. Take a UE initiated TA update as an example, in step S1802-1, the UE may transmit a TA re-acquisition message with the preamble (e.g., preamble corresponding to the preamble index) to the candidate cell. The UE may start a failure detection timer upon the TA re-acquisition message being transmitted. In step S1802-2, in response to the RACH preamble, the candidate cell may transmit a TA value to the serving cell. In step S1802-3, the serving cell may try to transmit the TA value to the UE. If the TA value does not reach the UE before the failure detection timer expires, the UE may determine that the TA update failure is detected.

After the TA update failure, if the execution condition is met, in step S1803, the UE may perform a RACH-based cell switch execution. Specifically, the UE may initiate a RA procedure, and consider the RACH-based cell switch to be ongoing.

In one example, the execution conditions may include one or more measurement-based conditions and conditions associated with validity of TA value. For example, the executions conditions may include a primary execution condition, a secondary execution condition, and an emergency execution condition. The primary execution condition may be a measurement-based condition. For example, the primary execution condition may include “the measurement of the candidate cell becomes better than the measurement of the serving cell by an offset”. The secondary execution condition may include “whether the candidate cell’s TA value is currently valid”. The emergency execution condition may be a measurement-based condition. For example, the emergency execution condition may include “the measurement of the serving cell becomes worse than a threshold”.

The UE may determine whether the primary execution condition is met. If the primary execution condition is met, the UE may determine whether the secondary execution condition is met. If the secondary condition is met, the UE may trigger a RACH-less cell switch execution. If the secondary execution condition is not met, the UE may determine whether the emergency execution condition is met. If the emergency execution condition is met, the UE may trigger a RACH-based cell switch execution. If the emergency execution condition is not met, the UE may wait for the TA acquisition/re-acquisition. For example, the UE may transmit a RACH preamble to the candidate cell to initiate a TA update.

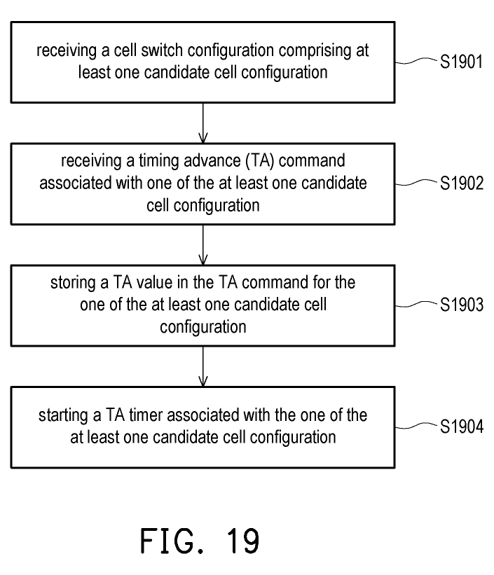

FIG. 19 illustrates a flowchart of a method of timing advance (TA) update according to one embodiment of the present disclosure, wherein the method may be implemented by a communication device (e.g., UE). In step S1901, receiving a cell switch configuration comprising at least one candidate cell configuration. In step S1902, receiving a timing advance (TA) command associated with one of the at least one candidate cell configuration. In step S1903, storing a TA value in the TA command for the one of the at least one candidate cell configuration. In step S1904, starting a TA timer associated with the one of the at least one candidate cell configuration.

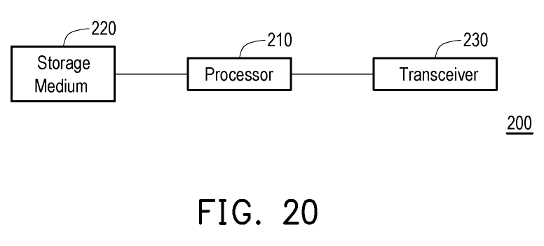

FIG. 20 illustrates a schematic diagram of UE 200 according to one embodiment of the present disclosure, wherein the UE may implement the method described in FIGS. 1-19 as well as their exemplary embodiments and alternative variations. The UE 200 may include a processor 210, a storage medium 220, and a transceiver 230. The processor 210 is coupled to the storage medium 220 and the transceiver 230.

The processor 210 could be implemented by using programmable units such as a micro-processor, a micro-controller, a digital signal processor (DSP), a field programmable gate array (FPGA), etc. The functions of the processor 110 may also be implemented with separate electronic devices or ICs. It should be noted that the functions of the processor 210 may be implemented with either hardware or software.

The storage medium 220 may be, for example, any type of fixed or removable random access memory (RAM), a read-only memory (ROM), a flash memory, a hard disc drive (HDD), a solid state drive (SSD) or similar element, or a combination thereof, configured to record a plurality of modules or various applications executable by the processor 210.

The transceiver 230 may be configured to transmit or receive signals respectively in the radio frequency. The transceiver 230 may also perform operations such as low noise amplifying, impedance matching, frequency mixing, up or down frequency conversion, filtering, amplifying, and so forth. The transceiver 230 may include one or more digital-to-analog (D/A) converters or analog-to-digital (A/D) converters which are configured to convert from an analog signal format to a digital signal format during uplink signal processing and from a digital signal format to a analog signal format during downlink signal processing. The transceiver 230 may include an antenna array which may include one or more antennas to transmit and receive omni-directional antenna beams or directional antenna beams.

Mobility latency influences data interruption, and thus user experience, during the cell switch. Therefore, RACH-less cell switch (i.e., no RACH procedure is needed during the cell switch), is important, especially when the UE experience frequent cell switches. The UE of the disclosure may obtain a cell switch configuration and may obtain a TA value from the TA command and start the TA timer. The UE may determine whether the TA value is valid according to the TA timer. If the UE has the valid TA value at the time of C-LTM execution, the UE may perform RACH-less C-LTM, otherwise the UE may perform RACH-based C-LTM. The disclosure may realize the early TA update at an appropriate time or design UE-evaluated conditions so that RACH-less switch can be facilitated as much as possible in conditional LTM.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method of timing advance (TA) acquisition, adapted to a user equipment, comprising:
receiving a cell switch configuration comprising at least one candidate cell configuration;
receiving a TA command associated with one of the at least one candidate cell configuration;
storing a TA value in the TA command for the one of the at least one candidate cell configuration; and
starting a TA timer associated with the one of the at least one candidate cell configuration.

2. The method according to claim 1, further comprising:
in response to the one of the at least one candidate cell configuration being released,
stopping the TA timer associated with the one of the at least one candidate cell configuration, if exist and running, and
releasing the stored TA value for the one of the at least one candidate cell.

3. The method according to claim 1, further comprising:
in response to the TA timer expiring,
initiating a random access procedure, and
considering a random access channel (RACH)-based cell switch to be ongoing.

4. The method according to claim 1, further comprising:
receiving a second TA command associated with the one of the at least one candidate cell configuration;
storing a second TA value in the second TA command for the one of the at least one candidate cell configuration; and
re-starting the TA timer associated with the one of the at least one candidate cell configuration.

5. The method according to claim 4, further comprising:
transmitting a random access preamble associated with the one of the at least one candidate cell configuration.

6. The method according to claim 5, wherein an index of the random access preamble is received by the user equipment via a step of receiving the TA command associated with the one of the at least one candidate cell configuration or the second TA command associated with the one of the at least one candidate cell configuration, wherein the step is performed prior to the random access preamble being transmitted.

7. The method according to claim 5, wherein the step of transmitting the random access preamble associated with the one of the at least one candidate cell configuration is initiated by a physical downlink control channel (PDCCH) order.

8. The method according to claim 5, wherein the random access preamble is used in an N-th subsequent physical random access channel (PRACH) occasion after receiving the index of the random access preamble, wherein N is a positive integer.

9. The method according to claim 5, wherein the random access preamble is used in a latest physical random access channel (PRACH) occasion before the TA timer expires.

10. The method according to claim 5, wherein the step of transmitting the random access preamble associated with the one of the at least one candidate cell configuration is performed a time offset before the TA timer expires.

11. The method according to claim 5, wherein the step of transmitting the random access preamble associated with the one of the at least one candidate cell configuration is performed after the TA timer expires.

12. The method according to claim 1, wherein the cell switch configuration further comprises at least one execution condition, and the method further comprising:
evaluating the at least one execution condition.

13. The method according to claim 12, wherein each one of the at least one execution condition is associated with each one of the at least one candidate cell configuration.

14. The method according to claim 13, wherein the each one of the at least one execution condition comprises a primary execution condition, a secondary execution condition, and an emergency execution condition, wherein the primary execution condition is a first measurement-based condition, the secondary execution condition is associated with a validity of TA value, and the emergency execution condition is a second measurement-based condition.

15. The method according to claim 14, further comprising:
determining whether the primary execution condition in one of the at least one execution condition is met;
in response to the primary execution condition in the one of the at least one execution condition being met, determining whether the secondary execution condition in the one of the at least one execution condition is met;
in response to the secondary execution condition in the one of the at least one execution condition being met, performing the cell switch as a random access channel (RACH)-less cell switch;
in response to the secondary execution condition in the one of the at least one execution condition not being met, determining whether the emergency condition in the one of the at least one execution condition is met;
in response to the emergency condition in the one of the at least one execution condition being met, performing the cell switch as a RACH-based cell switch; and
in response to the emergency condition in the one of the at least one execution condition not being met, transmitting a random access preamble associated with the one of the at least one candidate cell configuration.

16. A user equipment, comprising:
a transceiver; and
a processor, coupled to the transceiver, wherein the processor is configured to:
receive a cell switch configuration via the transceiver, wherein the cell switch configuration comprises at least one candidate cell configuration;
receive a timing advance (TA) command associated with one of the at least one candidate cell configuration;
store a TA value in the TA command for the one of the at least one candidate cell configuration; and
start a TA timer associated with the one of the at least one candidate cell configuration.
